(19) United States
(12) Patent Application Publication
(10) Pub. No.: US 2014/0289407 A1
(43) Pub. Date: Sep. 25, 2014

(54) GROUP CO-OWNERSHIP OF INTERNET-ACCESSIBLE RESOURCES

(71) Applicant: MICROSOFT CORPORATION, Redmond, WA (US)

(72) Inventors: Omar Shahine, Seattle, WA (US); Sarah Filman, Seattle, WA (US); Navjot Virk, Sammamish, WA (US); Mona Akmal, Kirkland, WA (US); Pooja Malhotra, Sammamish, WA (US); Jonathan A. Bockelman, Kirkland, WA (US); Daron Spektor, Seattle, WA (US)

(21) Appl. No.: 13/848,626

(22) Filed: Mar. 21, 2013

(51) Int. Cl. H04L 12/911

(52) U.S. Cl. CPC H04L 47/70
USPC 709/225

(57) ABSTRACT

In one embodiment, two separate user accounts may share equal ownership of the same internet-accessible resource 124. An internet-accessible resource service 122 may associate a source ownership status 316 for an internet-accessible resource 124 with a source user account owned by a source user. An internet-accessible resource service 122 may associate a target ownership status 366 for the internet-accessible resource 124 with a target user account owned by a target user.

### BACKGROUND

A user may create a user account with an internet-accessible resource service, such as a cloud service. An internet-accessible resource service interacts with a thin client resident on a user device, outsourcing a computer service to one or more computing devices distributed in a network, referred to as the cloud. An internet-accessible resource service may provide an internet-accessible resource, such as data storage, processing, an application, or other computing services, to the user device. Generally, each user account may have a quota for the internet-accessible resources provides to a user, with the user paying more for each tier of internet-accessible resource provided. For example, an internet-accessible data storage may provide seven gigabytes of storage for free, with every increment of ten gigabytes of storage provided beyond that costing more per month.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to sharing equal ownership of the same internet-accessible resource between two separate user accounts. An internet-accessible resource service may associate a source ownership status for an internet-accessible resource with a source user account owned by a source user. An internet-accessible resource service may associate a target ownership status for the internet-accessible resource with a target user account owned by a target user.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a resource network.

FIG. 2 illustrates, in a block diagram, one embodiment of a computing device.

FIGS. 3a-b illustrate, in block diagrams, two embodiments of resource management systems.

FIG. 4 illustrates, in a block diagram, one embodiment of an internet-accessible resource record.

FIG. 5 illustrates, in a flowchart, one embodiment of a method of sharing ownership of an internet-accessible resource by a source user account.

FIG. 6 illustrates, in a flowchart, one embodiment of a method of sharing ownership of an internet-accessible resource with a target user account by an internet-accessible resource service.

FIG. 7 illustrates, in a flowchart, one embodiment of a method of sharing ownership of an internet-accessible resource with an additional user account by an internet-accessible resource service.

FIG. 8 illustrates, in a flowchart, one embodiment of a method of closing an internet-accessible resource by an internet-accessible resource service.

FIG. 9 illustrates, in a flowchart, one embodiment of a method of receiving ownership of an internet-accessible resource in a target user account.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, a source user device, a target user device, or a resource server.

A user may use an internet-accessible resource service to create a collaborative environment for creating and sharing content with other users. The user may create a group internet-accessible resource with the intent of each recipient having equal ownership of the contents. After specifying the initial recipients list, the user may invite each recipient to “mount” the group internet-accessible resource in each user's individual user account. Mounting moves a resource into a core resource list on the user device. The group internet-accessible resource may be available along with other shared content in a shared content list until that user mounts the internet-accessible resource into the individual user core resource list.

Once the user mounts the internet-accessible resource in that user's core resource list, the internet-accessible resource may become functionally indistinguishable from any other personal resource. Owners of the group internet-accessible resource may synchronize the internet-accessible resource, add other owners, remove current owners, share the contents of the internet-accessible resource, move the internet-accessible resource, copy the internet-accessible resource, edit the internet-accessible resource, or access the content of the internet-accessible resource. The creator of the internet-accessible resource may hold the same administrative privileges over the contents of the internet-accessible resource as any of the other owners. In the case where an owner leaves the group internet-accessible resource, the group internet-accessible resource may continue to exist for other owners and does not disappear.

Thus, in one embodiment, two separate user accounts may share equal ownership of the same internet-accessible resource. An internet-accessible resource service may associate a source ownership status for an internet-accessible resource with a source user account owned by a source user. An internet-accessible resource service may associate a target ownership status for the internet-accessible resource with a target user account owned by a target user.

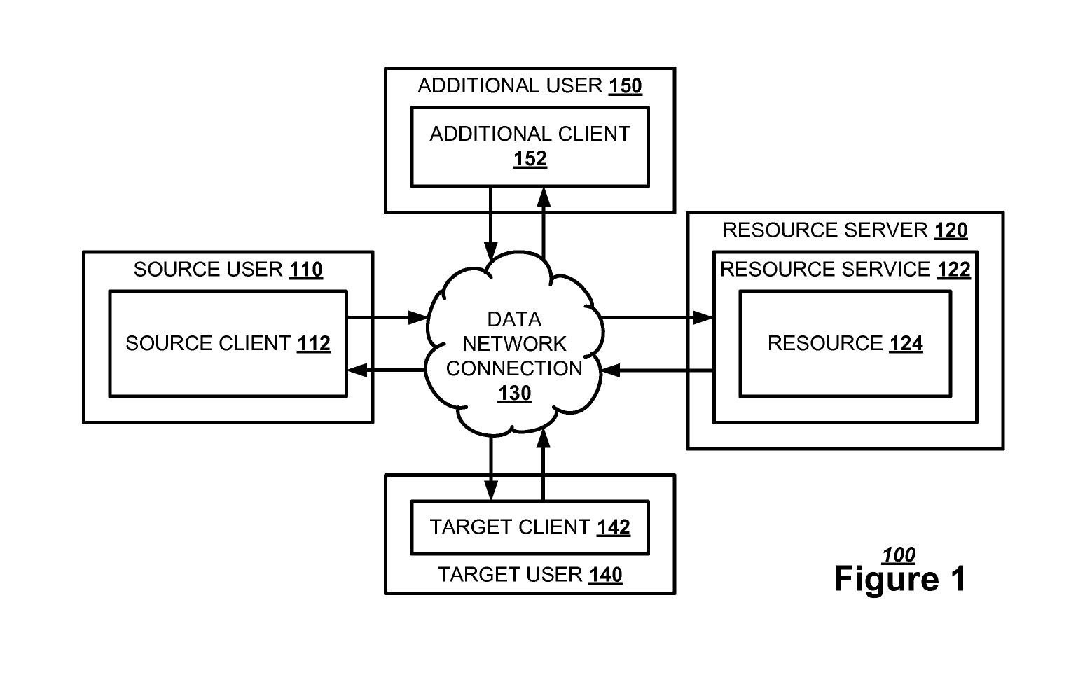

FIG. 1 illustrates, in a block diagram, one embodiment of a resource network 100. A source user device 110 may execute a source client 112 that connects to one or more resource servers 120 executing an internet-accessible resource service 122 via a data network connection 130. The data network connection 130 may be an internet connection, a wide area network connection, a local area network connection, or other type of data network connections. The source client 112 may be a thin client application native to the source user device 110 or a web application resident in a browser platform. The source client 112 may access the internet-accessible resource service 122 using a source user account of the internet-accessible resource service 122. The internet-accessible resource service 122 may manage one or more internet-accessible resources 124. The internet-accessible resource service 122 may allocate the internet-accessible resource to the source user account, so that the source user account owns the internet-accessible resource 124. The internet-accessible resource 124 may be data storage, processing, a software application, or other computing services. By owning the internet-accessible resource 124, the source user account may create, modify, delete, share, or convey full or partial ownership of the internet-accessible resource 124 without limitation imposed by a separate user account.

A target user device 140 may execute a target client 142 that accesses the internet-accessible resource service 122 using a target user account of the internet-accessible resource service 122. The target client 142 may be a thin client application native to the target user device 140 or a web application resident in a browser platform. The source user account may share equal ownership of the internet-accessible resource 124 with the target user account. The source user account may create ownership of the internet-accessible resource 124 by allocating the internet-accessible resource 124, or may have received ownership of the internet-accessible resource 124 from a previous user account. The source user account may have a source ownership status for the internet-accessible resource 124, while the target user account may have a target ownership status for the internet-accessible resource 124. The source ownership status and the target ownership status may be identical, with “source” and “target” merely denoting that two separate user accounts each have equal ownership of the internet-accessible resource 124. By co-owning the internet-accessible resource 124, the source user account and the target user account may create, modify, delete, share, or convey full or partial ownership of the internet-accessible resource 124 without limitation imposed by a separate user account. An additional user device 150 may execute an additional client 152 that accesses the internet-accessible resource service 122 using an additional user account of the internet-accessible resource service 122. The additional client 152 may be a thin client application native to the additional user device 150 or a web application resident in a browser platform. The source user account or the target user account may share equal ownership of the internet-accessible resource 124 with the additional user account. The additional user account may have an additional ownership status for the internet-accessible resource 124, equal and equivalent to the source ownership status or the target ownership status. By co-owning the internet-accessible resource 124, the additional user account may create, modify, delete, share, or convey full or partial ownership of the internet-accessible resource 124 without limitation imposed by a separate user account. Alternately, the source user account or the target user account may share the internet-accessible resource 124 with the additional user account, giving the additional user account additional share status over the internet-accessible resource 124. Additional share status may allow the additional user account the ability to create, modify, delete, or share the internet-accessible resource 124 subject to limitations set by the source user account or the target user account.

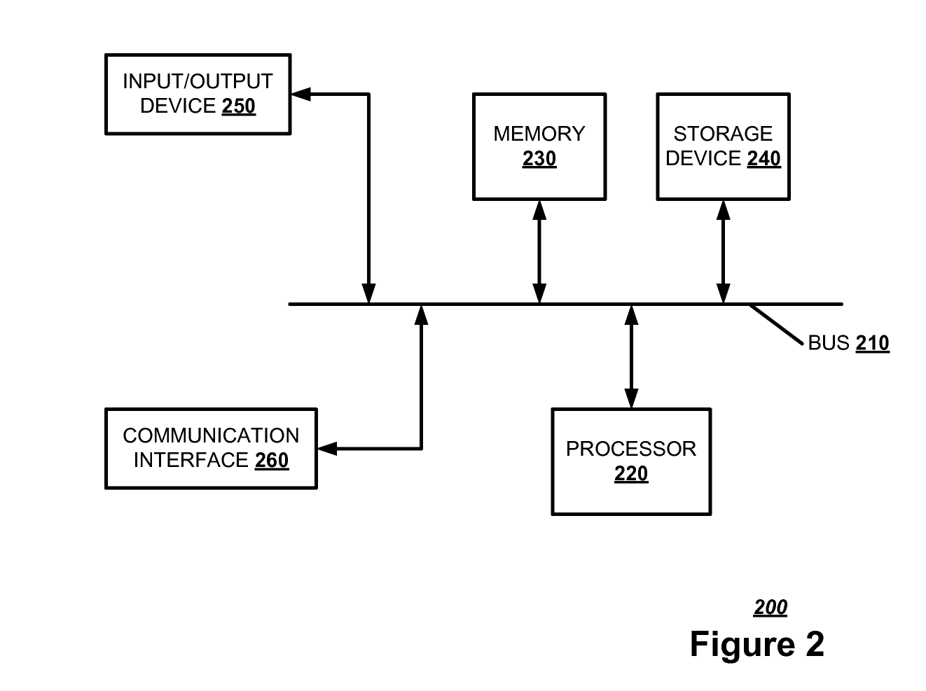

FIG. 2 illustrates a block diagram of an exemplary computing device 200 which may act as a source user device 110, a target user device 140, an additional user device 150, or a resource server 120. The computing device 200 may combine one or more of hardware, software, firmware, and system-on-a-chip technology to implement a source user device 110, a target user device 140, an additional user device 150, or a resource server 120. The computing device 200 may include a bus 210, a processor 220, a memory 230, a data storage 240, an input/output device 250, and a communication interface 260. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing internet-accessible resource records.

The input/output device 250 may include one or more conventional mechanisms that permit a user to input information to the computing device 200, such as a keyboard, a mouse, a voice recognition device, a microphone, a headset, a gesture recognition device, a touch screen, etc. The input/output device 250 may include one or more conventional mechanisms that output information to the user, including a display, a printer, one or more speakers, a headset, or a medium, such as a memory, or a magnetic or optical disk and a corresponding disk drive. The communication interface 260 may include any transceiver-like mechanism that enables computing device 200 to communicate with other devices or networks. The communication interface 260 may include a network interface or a transceiver interface. The communication interface 260 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

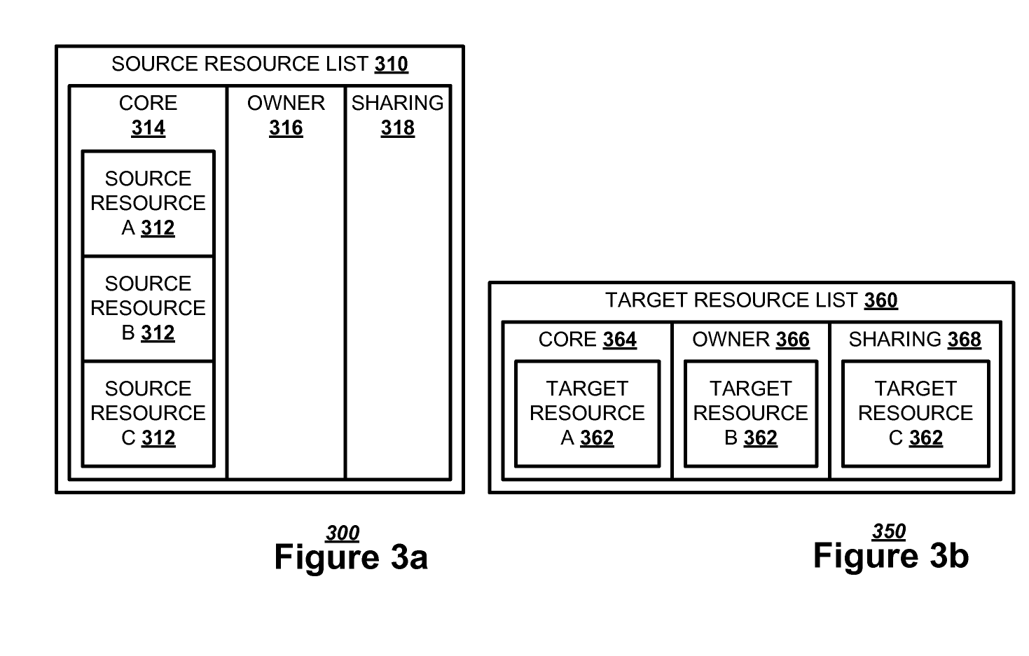

Each user account may store one or more internet-accessible resources 124 in the internet-accessible resource service 122. Depending on the possession status of the internet-accessible resource 124 in relation to the user account, the user device may present the internet-accessible resource to the user in different ways. FIG. 3a illustrates, in a block diagram, one embodiment of a source resource management system 300. A source resource list 310 may present one or more source resources, such as a source internet-accessible resource 312, accessible by the source user account. The source internet-accessible resource 312 is a copy on the source user device 110 of an internet-accessible resource 124 stored in the internet-accessible resource service 122. The source internet-accessible resource 312 may have a possession status of source core status 314, source ownership status 316, and source sharing status 318. A source core status 314 describes a source internet-accessible resource 312 that appears among the standard list of resources stored on the source user device 110. A source ownership status 316 is a source internet-accessible resource 312 that the source user account owns, with no limitations applied by a separate user account. A source client 112 may move a source internet-accessible resource 312 to source core status 314 by mounting the source internet-accessible resource 312. A mounted source internet-accessible resource 312 may still have source ownership status 316 while having source core status 314. A source share status 318 is a source internet-accessible resource 312 that the source user account may access, subject to limitations applied by a separate user account.

The source user account may provide varying levels of access to various internet-accessible resources to a target user account. For example, source user device 110 may have a source internet-accessible resource A 312, a source internet-accessible resource B 312, and a source internet-accessible resource C 312, each having a source core status 314. The source user account may provide varying degrees of access of each of these source internet-accessible resources 312 to a target user account. FIG. 3b illustrates, in a block diagram, one embodiment of a target resource management system 350. The target resource list 360 may display each of these target internet-accessible resources 362 with a possession status, such as a target core status 364, a target ownership status 366, and a target sharing status 368. A target internet-accessible resource is a copy on the target user device 140 of an internet-accessible resource 124 stored in the internet-accessible resource service 122.

The source user account may assign target ownership status 366 for the target user account to the target internet-accessible resource A 362 and target internet-accessible resource B 362, while providing target sharing status 368 to target internet-accessible resource C 362. The target user device 140 may mount the target internet-accessible resource A 362, raising target internet-accessible resource A 362 to include target core status 364 in addition to target ownership status 366. Thus, target internet-accessible resource A 362 may appear as a resource in the resource list of the target user device 140. The target user account may have full ownership privileges for the target internet-accessible resource B 362, but the target internet-accessible resource B 362 does not appear among the resource list of the target user device 140. The target user account may have access to target internet-accessible resource C 362, subject to limitations put in place by the source user account.

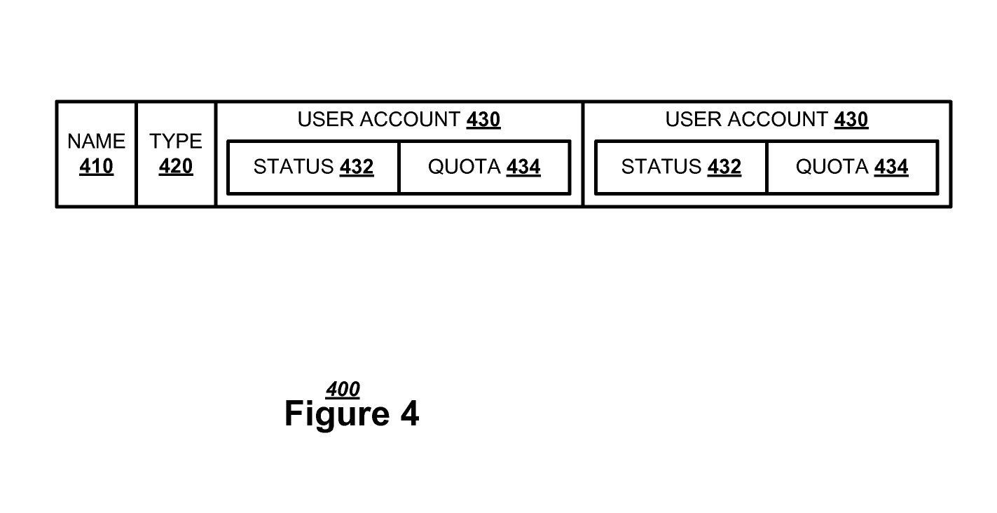

Each internet-accessible resource 124 may be present in the internet-accessible resource service 122. The internet-accessible resource service 122 may maintain an internet-accessible resource record tracking the possession status for each user account with access to the internet-accessible resource 124. FIG. 4 illustrates, in a block diagram, one embodiment of an internet-accessible resource record 400. The internet-accessible resource record 400 may have a name field 410 labeling the internet-accessible resource 124. The internet-accessible resource record 400 may have a type field 420 describing the type of internet-accessible resource 124. The internet-accessible resource record 400 may have a user account field 430 for each user account with access to the internet-accessible resource 124. The user account filed 430 may have a possession status sub-field 432 describing the possession status of the user account, such as sharing status or ownership status. The user account field 430 may have a user quota sub-field 434 describing how much of the internet-accessible resource 124 counts against any user quotas.

For example, the internet-accessible resource 124 may be data storage, and the user account may have a quota of ten gigabytes of data storage. The internet-accessible resource 124 may consume 3.2 gigabytes of storage. If two user accounts have ownership of the internet-accessible resource, the entire 3.2 gigabytes may be counted against the user quota of both user accounts, leaving both user accounts with 6.8 gigabytes of storage free. Alternately, the 3.2 gigabytes may be split between the two user account quotas. The split may be even, apportioned so that a primary user bears most of the cost, or apportioned so that the user account with the most available user quota bears most of the cost. For example, in an even split, the 3.2 gigabytes of storage would have 1.6 gigabytes counted against one quota and 1.6 gigabytes counted against the other quota.

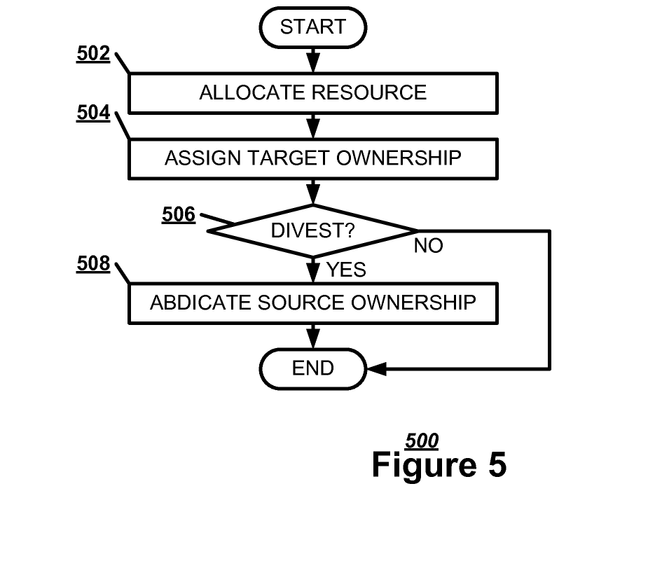

FIG. 5 illustrates, in a flowchart, one embodiment of a method 500 of sharing ownership of an internet-accessible resource 124 by a source user account. The source user account may allocate an internet-accessible resource 124 to create a source ownership status 316 of the internet-accessible resource 124 in an internet-accessible resource service 122 (Block 502). The source user account may direct the internet-accessible resource service 122 to assign a target ownership status 366 in the internet-accessible resource 124 to a target user account of the internet-accessible resource service 122 (Block 504). If the source user account is seeking to divest itself of the internet-accessible resource 124 (Block 506), the source user account may abdicate the source ownership status of the internet-accessible resource 124 (Block 508). By abdicating, the source user account may remove ownership of the internet-accessible resource 124. The source user account may later reclaim ownership of the internet-accessible resource 124 unless specifically barred by the target user account.

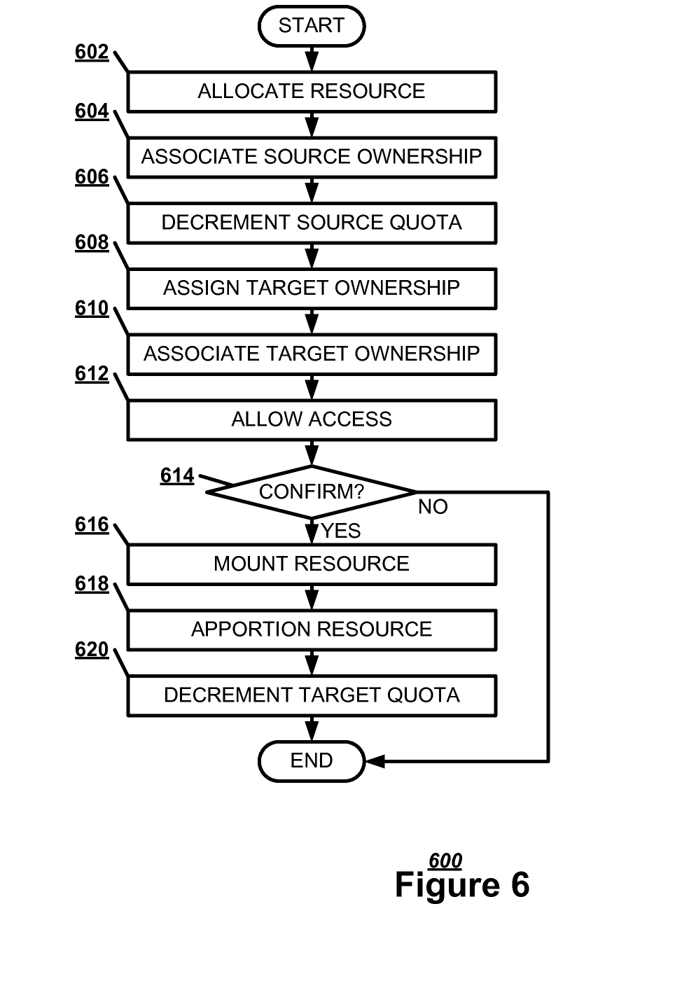

FIG. 6 illustrates, in a flowchart, one embodiment of a method 600 of sharing ownership of an internet-accessible resource 124 with a target user account by an internet-accessible resource service 122. The internet-accessible resource service 122 may allocate an internet-accessible resource 124 to create a source ownership status 316 of the internet-accessible resource 124 for a source user account (Block 602). The internet-accessible resource service 122 may associate the source ownership status 316 for the internet-accessible resource 124 with a source user account of the internet-accessible resource service 122 owned by a source user (Block 604). The internet-accessible resource service 122 may decrement a source user quota for the source user account based on the internet-accessible resource 124 (Block 606). The internet-accessible resource service 122 may assign a target ownership status 366 for the internet-accessible resource 124 to a target user account of the internet-accessible resource service 122 owned by a target user as directed by the source user (Block 608). The internet-accessible resource service 122 may associate the target ownership status 366 for the internet-accessible resource with the target user account (Block 610). The internet-accessible resource service 122 may allow access to the internet-accessible resource by the target user account prior to mounting (Block 612). If the internet-accessible resource service 122 receives a confirmation from the target user (Block 614), the internet-accessible resource service 122 may mount the internet-accessible resource 124 in the target user account (Block 616). The internet-accessible resource service 122 may apportion the internet-accessible resource 124 between the source user quota for the source user account and a target user quota for the target user account (Block 618). The internet-accessible resource service 122 may decrement a target user quota for the target user account based on the internet-accessible resource (Block 620).

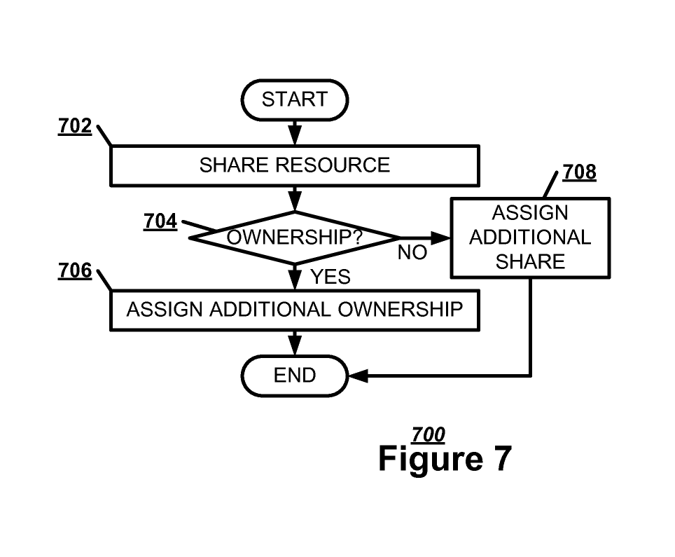

FIG. 7 illustrates, in a flowchart, one embodiment of a method 700 of sharing ownership of an internet-accessible resource 124 with an additional user account by an internet-accessible resource service 122. The internet-accessible resource service 122 may share an internet-accessible resource 124 owned by a source user account and a target user account with an additional user account at the direction of the target user account or the source user account (Block 702). If the target user or the source user seeks to assign an ownership interest in the internet-accessible resource 124 (Block 704), the internet-accessible resource service 122 may assign an additional ownership status for the internet-accessible resource 124 to the additional user account owned by an additional user as directed by the target user or the source user (Block 706). If the target user or the source user seeks to assign a sharing interest in the internet-accessible resource 124 (Block 704), the internet-accessible resource service 122 may assign an additional sharing status for the internet-accessible resource 124 to the additional user account owned by an additional user as directed by the target user or the source user (Block 708).

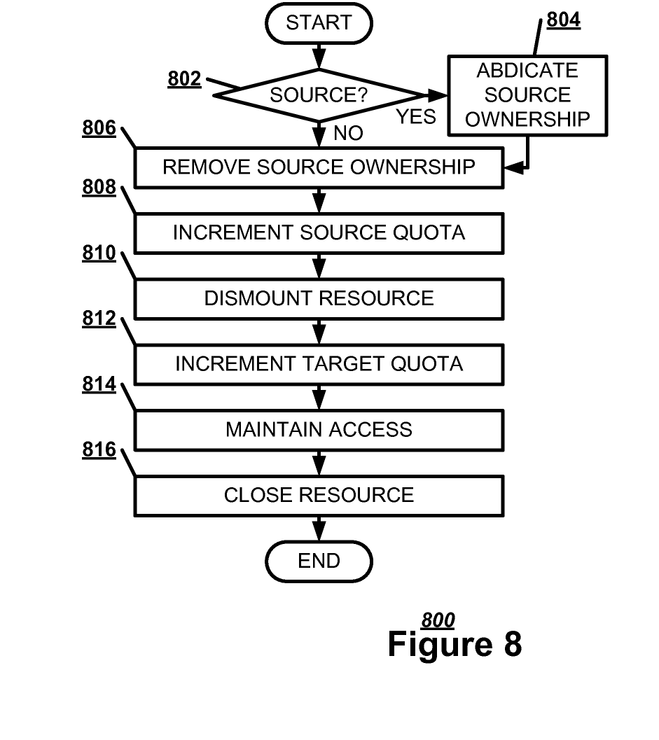

FIG. 8 illustrates, in a flowchart, one embodiment of a method 800 of closing an internet-accessible resource 124 by an internet-accessible resource service 122. If the source user seeks to abdicate ownership of the internet-accessible resource 124 (Block 802), the internet-accessible resource service 122 may remove the source ownership status 316 for the internet-accessible resource 124 from the source user account as directed by the source user (Block 804). If the target user seeks to remove the source user from ownership of the internet-accessible resource 124 (Block 802), the internet-accessible resource service 122 may remove the source ownership status for the internet-accessible resource 124 from the source user account as directed by the target user (Block 806). The internet-accessible resource service 122 may increment a source user quota for the source user account based on the internet-accessible resource 124 (Block 808). The internet-accessible resource service 122 may dismount the internet-accessible resource 124 in the target user account (Block 810). The internet-accessible resource service 122 may increment the target user quota for the target user account based on the internet-accessible resource 124 (Block 812). The internet-accessible resource service 122 may maintain access to the internet-accessible resource 124 by the target user account after the internet-accessible resource is dismounted from the target user account (Block 814). The internet-accessible resource service 122 may close the internet-accessible resource 124 as directed by the target user (Block 816).

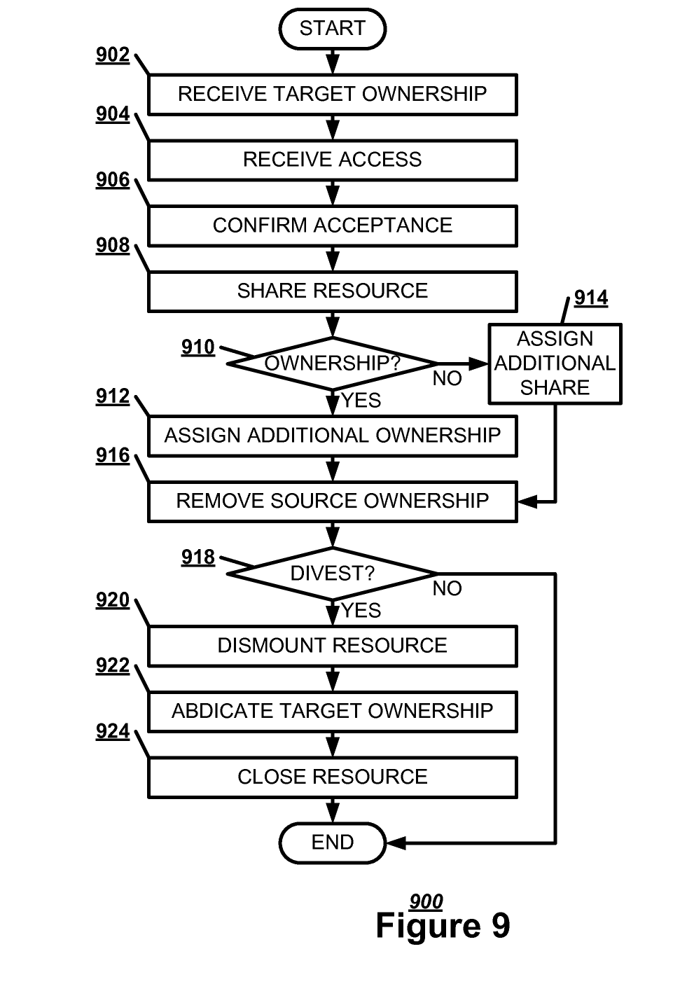

FIG. 9 illustrates, in a flowchart, one embodiment of a method 900 of receiving ownership of an internet-accessible resource 124 in a target user account. The target user account of an internet-accessible resource service 122 owned by a target user may receive a target ownership status 366 for an internet-accessible resource 124 from a source user account of the internet-accessible resource service 122 owned by a source user having a source ownership status 316 of the internet-accessible resource 124 (Block 902). The target user account may receive access to the internet-accessible resource 124 (Block 904). The target user account may confirm acceptance of the target ownership status 366 for the internet-accessible resource 124 to mount the internet-accessible resource 124 (Block 906). The target user account may share the internet-accessible resource 124 with an additional user account (Block 908). If the target user account seeks to convey ownership in the internet-accessible resource 124 to the additional user account (Block 910), the target user account may direct the internet-accessible resource service 122 to assign an additional ownership status for the internet-accessible resource 124 to the additional user account owned by an additional user (Block 912). If the target user account seeks to convey a sharing interest in the internet-accessible resource 124 to the additional user account (Block 910), the target user account may direct the internet-accessible resource service 122 to assign an additional sharing status for the internet-accessible resource 124 to the additional user account owned by the additional user (Block 914). The target user account may direct the internet-accessible resource service 122 to remove the source ownership status 316 for the internet-accessible resource 124 from the source user account (Block 916). If the target user account is seeking to divest itself of the internet-accessible resource 124 (Block 918), the target user account may dismount the internet-accessible resource 124 (Block 920). The target user account may abdicate the target ownership status of the internet-accessible resource 124 (Block 922). The target user account may direct the internet-accessible resource service 122 to close the internet-accessible resource 124 (Block 924).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose Docket No. 338221.01 computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
associating a source ownership status for an internet-accessible resource with a source user account of an internet-accessible resource service owned by a source user; and
associating a target ownership status for the internet-accessible resource with a target user account of the internet-accessible resource service owned by a target user.

2. The method of claim 1, further comprising:
mounting the internet-accessible resource in the target user account.

3. The method of claim 1, further comprising:
allowing access to the internet-accessible resource by the target user account prior to mounting.

4. The method of claim 1, further comprising:
assigning the target ownership status for the internet-accessible resource to the target user account as directed by the source user.

5. The method of claim 1, further comprising:
removing the source ownership status for the internet-accessible resource from the source user account as directed by the target user.

6. The method of claim 1, further comprising:
removing the source ownership status for the internet-accessible resource from the source user account as directed by the source user.

7. The method of claim 1, further comprising:
assigning an additional ownership status for the internet-accessible resource to an additional user account owned by an additional user as directed by the target user.

8. The method of claim 1, further comprising:
maintaining access to the internet-accessible resource by the target user account after the internet-accessible resource is dismounted from the target user account.

9. The method of claim 1, further comprising:
closing the internet-accessible resource as directed by the target user.

10. The method of claim 1, further comprising:
decrementing a source user quota for the source user account based on the internet-accessible resource.

11. The method of claim 1, further comprising:
decrementing a target user quota for the target user account based on the internet-accessible resource.

12. The method of claim 1, further comprising:
apportioning the internet-accessible resource between a source user quota for the source user account and a target user quota for the target user account.

13. A tangible machine-readable medium having a set of instructions detailing a method stored thereon that when executed by one or more processors cause the one or more processors to perform the method, the method comprising:
receiving in a target user account of an internet-accessible resource service owned by a target user a target ownership status for an internet-accessible resource from a source user account of the internet-accessible resource service owned by a source user having a source ownership status of the internet-accessible resource; and
receiving access to the internet-accessible resource in the target user account.

14. The tangible machine-readable medium of claim 13, wherein the method further comprises:
confirming acceptance of the target ownership status for the internet-accessible resource.

15. The tangible machine-readable medium of claim 13, wherein the method further comprises:
directing the internet-accessible resource service to assign an additional ownership status for the internet-accessible resource to an additional user account owned by an additional user.

16. The tangible machine-readable medium of claim 13, wherein the method further comprises:
directing the internet-accessible resource service to assign an additional sharing status for the internet-accessible resource to an additional user account owned by an additional user.

17. The tangible machine-readable medium of claim 13, wherein the method further comprises:
directing the internet-accessible resource service to remove the source ownership status for the internet-accessible resource from the source user account.

18. The tangible machine-readable medium of claim 13, wherein the method further comprises:
directing the internet-accessible resource service to close the internet-accessible resource.

19. A source user device, comprising:
a processor that maintains a source user account client to interface with a source user account in an internet-accessible resource service create a source ownership status of an internet-accessible resource in the internet-accessible resource service; and
a communication interface that directs the internet-accessible resource service to assign a target ownership status in the internet-accessible resource to a target user account of the internet-accessible resource service.

20. The source user device of claim 19, wherein the source user account abdicates the source ownership status of the internet-accessible resource.
